(19) United States
(12) Patent Application Publication
(10) Pub. No.: US 2009/0003402 A1
(43) Pub. Date: Jan. 1, 2009

(54) Semiconductor-laser pumped Ti:sapphire laser

(76) Inventors: Joris Van Nunen, EA Twello (NL); Hailong Zhou, Milpitas, CA (US); H. Yang Pang, San Jose, CA (US)

Correspondence Address: STALLMAN & POLLOCK LLP, 353 SACRAMENTO STREET, SUITE 2200, SAN FRANCISCO, CA, 94111, US

(21) Appl. No.: 11/824,438

(22) Filed: Jun. 29, 2007

(51) Int. Cl. H01S 3/0941; H01S 3/091

(52) U.S. Cl. 372/72; 372/75

(57) ABSTRACT

A laser includes a Ti:sapphire gain-element that is optically pumped by radiation from a semiconductor laser device. In one example the semiconductor laser device is an InGaN diode-laser array and the gain-element is optically pumped by radiation emitted by that array. In another example, the semiconductor laser device is an optically pumped semiconductor laser (OPS-laser) optically pumped by radiation from an InGaN diode-laser array. In a further example the semiconductor device is an intracavity frequency-doubled OPS laser.

### TECHNICAL FIELD OF THE INVENTION

The present invention relates in general to lasers and amplifiers including a titanium-doped sapphire (Ti:sapphire) gain-medium. The invention relates in general to arrangements for optically pumping the gain-medium in such lasers and amplifiers.

### DISCUSSION OF BACKGROUND ART

Ti:sapphire is the gain-medium of choice for modelocked laser and laser-amplifier systems delivering ultrashort pulses, for example pulses having a duration less than about 100 femtoseconds (fs). Ti:sapphire has a gain-bandwidth at half peak gain extending between wavelengths of about 700 nanometers (nm) and 900 nm. Optical pump radiation can be absorbed over a relatively broad spectrum with a bandwidth at half maximum absorption extending from about 460 nm to 600 nm. The absorption spectrum is skewed towards shorter wavelength with the peak gain being at a wavelength between of about 500 nm.

In early experimental lasers having a Ti:sapphire gain-medium, the gain-medium was optically pumped by radiation from a dye-laser tunable to an output wavelength matching the peak-gain wavelength of the Ti-sapphire, or by an argon-ion (gas) laser that has output wavelengths of about 489 nm and about 515 nm close enough to the peak-gain wavelength such that absorption thereof was about 90% of the absorption at the peak-gain wavelength. Dye-lasers and argon ion lasers are not favored for commercially produced ultrafast lasers. Dye lasers are maintenance intensive, and argon ion-lasers are bulky and very inefficient.

Commercially available Ti-sapphire lasers are usually pumped by frequency-doubled, diode-pumped solid-state (DPSS) lasers including a gain-medium of neodymium-doped yttrium-iron garnet (Nd:YAG), neodymium-doped yttrium vanadate (Nd:YVO₄), or neodymium-doped yttrium lithium fluoride (Nd:YLF). These gain-media provide laser radiation at a fundamental wavelength of about 1064 nm. Frequency doubling (which can be intra-cavity or extra-cavity frequency-doubling) converts the fundamental wavelength radiation to second-harmonic (2H) radiation having a wavelength of about 532 nm. While this wavelength is further from the peak-gain wavelength of Ti:sapphire than radiation from a tunable dye-laser or an argon-ion laser, the skewed form of the absorption-curve of the Ti:sapphire allows that the absorption of the 532 nm radiation can be as high as about 75% of the peak-absorption. As DPSS lasers are efficient, reliable, and produced in quantity for a variety of laser applications, the use of such lasers for Ti:sapphire pumping is convenient, and this convenience compensates in some measure for the less-than-optimum absorption of the output by the Ti:sapphire.

Convenience aside, however, a frequency-doubled DPSS laser having adequate power for pumping and providing a low-noise output beam is not an inexpensive laser. Because of this, the pump-laser can contribute as much as 50% of the cost of a Ti:sapphire laser. The dimensions of the frequency-doubled DPSS laser are also about the same as those of the Ti:sapphire laser being pumped. The Ti:sapphire laser is usually configured with the DPSS pumping laser and the laser being pumped as separate units, which must be kept in precise alignment. The situation becomes even more complex in a Ti:sapphire laser system including a Ti:sapphire laser functioning as a master oscillator, the output of which is amplified by a power amplifier of some kind (single pass, multiple pass, or regenerative) also including a Ti:sapphire gain-medium. Here, two frequency-doubled DPSS lasers would be required, one for pumping the master oscillator and the other for pumping the amplifier.

The relatively high cost and inconvenient configuration of frequency-doubled DPSS-laser-pumped Ti:sapphire lasers and laser/amplifier systems presently discourage the use thereof for applications such as laser machining and medical applications. It is believed that if Ti:sapphire lasers could be pumped by a smaller and less expensive pump-radiation source the range of applications for such lasers would significantly expand.

### SUMMARY OF THE INVENTION

The present invention is directed to arrangements for optically pumping a Ti:sapphire gain-medium in a laser oscillator or amplifier using a semiconductor laser device. In a general aspect, apparatus in accordance with the present invention comprises a master oscillator or an amplifier including a Ti:sapphire gain-medium. The apparatus includes an optical pumping arrangement including a semiconductor laser device arranged to generate and deliver optical pump radiation to said Ti:sapphire gain medium.

In one particular aspect the semiconductor laser device includes an indium gallium nitride (InGaN) diode-laser array. In one embodiment of the present invention, the semiconductor laser device is an InGaN diode-laser array and radiation emitted by the InGaN diode-laser array is used to directly optically pump the Ti:sapphire gain medium. In another embodiment of the present invention, the semiconductor laser device is an optically pumped semiconductor laser (OPS-laser) having active layers of a II-VI semiconductor material formulated to generate laser radiation at wavelength within a range of wavelengths including the peak-absorption wavelength of the Ti:sapphire gain-medium. An output beam from the OPS-laser is focused into the Ti:sapphire gain medium. The II-VI OPS-laser is optically pumped by radiation from the InGaN diode-laser array.

In another particular aspect of the present invention, the semiconductor laser device is an intracavity frequency-doubled OPS-laser having a gain-structure including active layers of a III-V semiconductor. The OPS-laser is optically pumped by radiation from a III-V diode-laser array. A beam of frequency-doubled radiation is delivered from the frequency-doubled OPS laser and is focused into the Ti:sapphire gain-medium.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates, in block diagram form, a commonly used prior-art arrangement for pumping an ultrafast laser resonator having a Ti:sapphire gain-medium, wherein a near infrared (NIR) diode-laser array optically pumps a 1064 nm solid-state laser, the output of which is frequency-doubled to provide 532 nm radiation that is used to optically pump the Ti-sapphire laser.

FIG. 2 schematically illustrates, in block diagram form, one preferred embodiment of an ultrafast laser in accordance with the present invention wherein a Ti:sapphire laser resonator is optically pumped by radiation delivered by an InGaN diode-laser array.

FIG. 3 is a graph schematically illustrating relative gain and relative absorption as a function of wavelength for a Ti:sapphire gain-medium.

FIG. 4 schematically illustrates one example of the laser of FIG. 2, tunable in the gain-range of the Ti:sapphire gain medium and in which radiation from the InGaN diode-laser array is transported to the resonator of the Ti:sapphire laser via an optical fiber, with lenses being provided for focusing the output of the optical fiber into a Ti:sapphire gain-element located in the resonator.

FIG. 5 schematically illustrates, in block diagram form, another preferred embodiment of an ultrafast laser in accordance with the present invention wherein radiation from an InGaN diode-laser array is used to optically pump an external cavity II-VI semiconductor laser resonator (OPS-laser resonator), the output of which is used to optically pump a Ti:sapphire laser.

FIG. 6 schematically illustrates one example of the laser of FIG. 5, tunable in the gain range of the Ti:sapphire gain-medium, similar to the laser of FIG. 4 but wherein fiber-delivered radiation from the InGaN diode-laser array is focused onto a multilayer gain structure of a II-VI OPS-laser resonator, the output of which used to pump the Ti:sapphire laser resonator.

FIG. 7 schematically illustrates, in block diagram form, yet another preferred embodiment of an ultrafast laser in accordance with the present invention, wherein radiation from an intracavity, frequency-doubled, III-V NIR OPS laser, is used to optically pump a Ti:sapphire laser resonator.

FIG. 8 schematically illustrates one example of the laser of FIG. 7, tunable in the gain range of the Ti:sapphire gain medium, similar to the laser of FIG. 4 but wherein fiber-delivered radiation from a III-V NIR diode-laser array is focused onto a multilayer gain-structure of an intracavity frequency doubled III-V OPS laser resonator, the output of which used to pump the Ti:sapphire laser resonator.

### DETAILED DESCRIPTION OF THE INVENTION

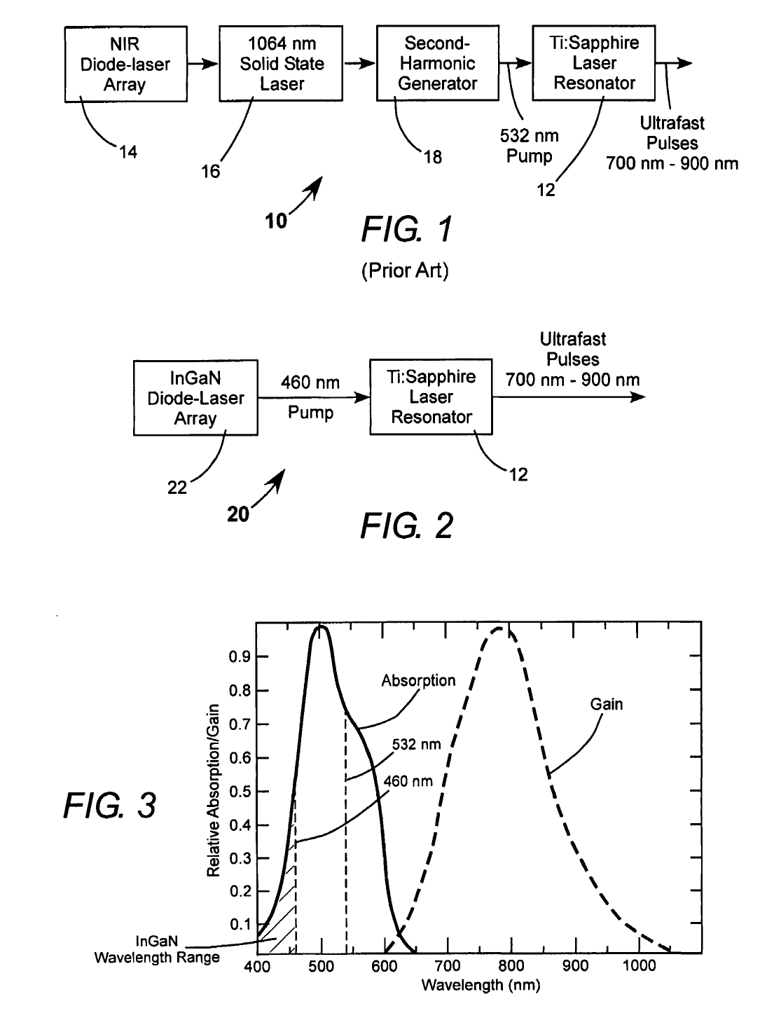

Referring now to the drawings, wherein like components are designated by like reference numerals, FIG. 1 schematically illustrates in block diagram form a commonly used prior-art arrangement 10 for pumping an ultrafast laser resonator 12 having a Ti:sapphire gain-medium (not explicitly shown). A near infrared (NIR) diode-laser array 14, diode-lasers of which are formed from III-V semiconductor materials such as InₓGa₍₁₋ₓ₎As, optically pumps a 1064 nm solid-state laser 16. In the aforementioned InₓGa₍₁₋ₓ₎As lasers, the emitted radiation has a fundamental wavelength selected by selecting an appropriate value for x, as is known in the art. The fundamental wavelength output of solid-state laser 16 is directed into a second-harmonic (2H) generator 18. 2H-generator 18 includes an optically nonlinear crystal (not shown) arranged to frequency-double the fundamental wavelength-radiation to provide 2H radiation having a wavelength of about 532 nm. The 532 nm-radiation is used to optically pump Ti-sapphire laser resonator 12.

FIG. 2 schematically illustrates, in block diagram form, one preferred embodiment 20 of an ultrafast laser in accordance with the present invention. Here, the Ti:sapphire laser resonator 12 is optically pumped by radiation delivered by a diode-laser array, emitters (diode-lasers) of which are formed from layers of indium gallium nitride, a III-V semiconductor having a general formula InₓGa₍₁₋ₓ₎N_{y}As_{(1-y)} where x and y are equal to or greater than 0.0 and less than or equal to 1.0. This general formula is usually abbreviated to simply InGaN by practitioners of the art, and is referred to as such herein for brevity. The diode lasers (emitters) can be made to emit at a particular wavelength in a spectral range from about 390 nanometers (nm) in the ultraviolet region of the electromagnetic spectrum to about 460 nm, at present, in the blue region of that spectrum by selecting an appropriate value for x, as is known in the art. It is possible that continued development of InGaN materials could eventually allow emission at wavelengths longer than 460 nm.

The use of the term “InGaN diode-laser array” recognizes that the output of a single diode-laser will be inadequate in practice to provide sufficient power for pumping a Ti:sapphire gain medium. The array, however, can have any form. By way of example, the array can be an orderly or disorderly array of individual diode-lasers on individual substrates, or a longitudinal array of InGaN diode-lasers formed in a common semiconductor heterostructure on a single substrate, usually designated a “diode-laser bar” by practitioners of the art. The array can include diode-laser bars arranged one above the other to form a two dimensional array, with diode-laser bars either on separate heat conductive sub-mounts or soldered together, one on top of another. This latter technique is described in detail in U.S. patent application Ser. No. 11/546,227, filed Oct. 11, 2006, assigned to the assignee of the present invention and the complete disclosure of which is hereby incorporated by reference.

Whatever the form of the InGaN diode-laser array, it can be seen that laser 20 is considerably simpler in content than prior-art laser 10. Other factors, however, must be considered, a discussion of which is set forth below.

FIG. 3 is a graph schematically illustrating relative gain (dashed curve) and relative absorption (solid curve) as a function of wavelength for a Ti:sapphire gain-medium. The absorption peaks at a wavelength of about 500 nm. The prior art 532 nm pump wavelength is 32 nm longer than the absorption-peak wavelength. However, as the absorption spectrum peak is skewed to shorter wavelengths, and the absorption spectrum has a “shoulder” at longer wavelengths, the absorption at 532 nm is about 75% of the peak value. It should be noted here that the absolute absorption will depend on the percentage doping of titanium in the sapphire host.

On a first consideration, InGaN diode-lasers would seem not to provide a suitable source for pump radiation as even the longest wavelength (460 nm) currently available from such diode-lasers is absorbed 50% less than at the peak wavelength and the absorption for the shortest wavelength is less than 5% of the peak value. A shaded area under the absorption curve (absorption spectrum) indicates the range of InGaN diode-laser wavelengths. What must be considered, however is that in making a comparison with the usual prior-art, the comparison should not be with the absorption at the peak-absorption wavelength but with the absorption at 532 nm. In this comparison, the absorption of 460 nm is about 67% of the 532 nm-value. What must also be taken into account is that in the prior-art arrangement there is less than 100% efficiency of converting the III-V diode-laser radiation into 1064 nm radiation and less than 100% efficiency of converting 1064 nm radiation to 532 nm.

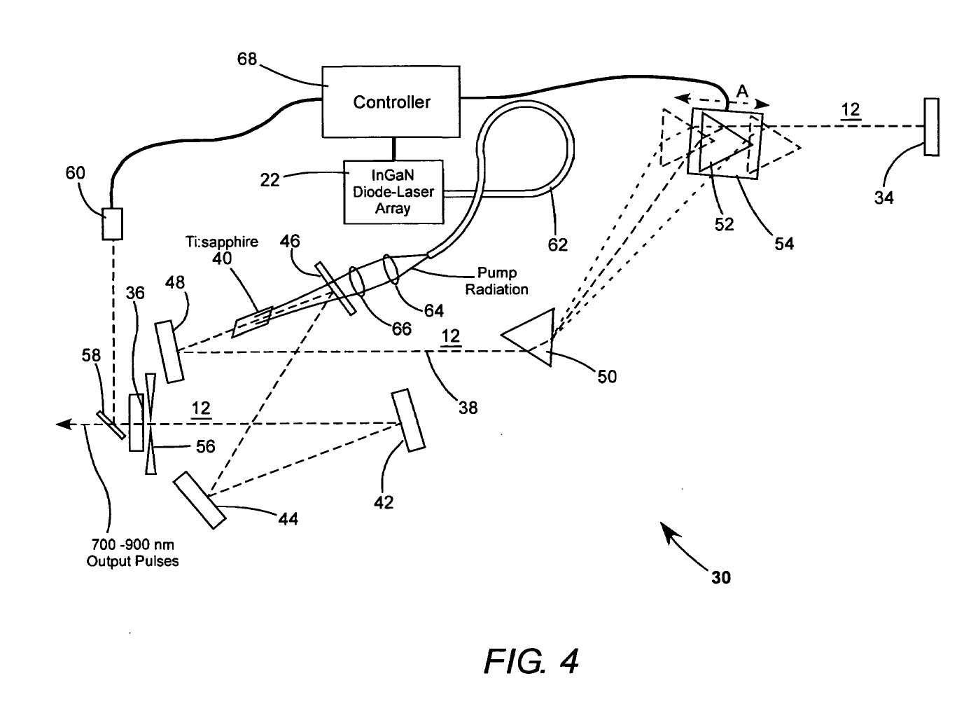

FIG. 4 schematically illustrates one example 30 of laser 20 of FIG. 2. In laser 30, laser resonator 12 is formed between a maximally reflecting (over the gain bandwidth of Ti:sapphire—see FIG. 3) mirror 34 and a partially transmissive mirror 36 that functions as an output coupling mirror. The longitudinal axis of resonator 12 is indicated by dashed line 38. This resonator-axis is multiply folded by mirrors 42, 44, 46, and 48, all of which are maximally reflective over the gain-bandwidth of Ti:sapphire. Mirror 46 is highly transmissive, for example greater than 95% transmissive, at the pump-radiation wavelength. A Ti:sapphire gain-element 40 (gain-medium) is located between mirrors 46 and 48. The resonator is thus folded to reduce the physical “footprint” of the resonator and to facilitate delivery of pump radiation to the Ti:sapphire gain-element. Pump radiation is delivered to gain-element 40 through mirror 46. Resonator 12, here, is a Kerr Lens modelocked resonator that is modelocked by a nonlinear Kerr effect in gain-element 40 in combination with an aperture 56 immediately in front of output coupling mirror 36. (See, U.S. Pat. No. 5,079,772, incorporated herein by reference.)

Resonator 12 includes prisms 50 and 52 arranged to provide negative group delay dispersion (negative GDD) in the resonator to offset pulse-broadening due to positive GDD effects otherwise inherent in the resonator. Prism 52 is mounted on a platform 54 that is translatable as indicated by arrow A for tuning the output wavelength over the gain-bandwidth of the Ti:sapphire gain element. A sampling mirror 58 directs a small sample, for example less than 1%, of the output of resonator 12 to a detector 60 cooperative with a controller 68 for providing power-measurement and control.

Optical pump radiation generated by InGaN diode-laser array 22 is transported via an optical fiber bundle 62 or, alternatively, a multimode optical fiber, to lenses 64 and 66. These lenses are arranged to focus the pump radiation into Ti:sapphire gain-element 40. Several methods for collecting radiation from individual diode-lasers and channeling that radiation into a fiber bundle or into a single fiber via a multiplexer are known in the art and detailed description of any of these methods is not necessary for understanding principle of the present invention. Accordingly, such a detailed description is not presented herein. As laser 30 is tuned over the permitted tuning range and pump radiation power remains constant, output power will vary according to the location of the tuned wavelength in the Ti:sapphire gain-spectrum. Controller 68 can be arranged to vary drive-current to the InGaN diode-laser array to vary pump power to compensate for the change in gain and thus maintain a constant output power.

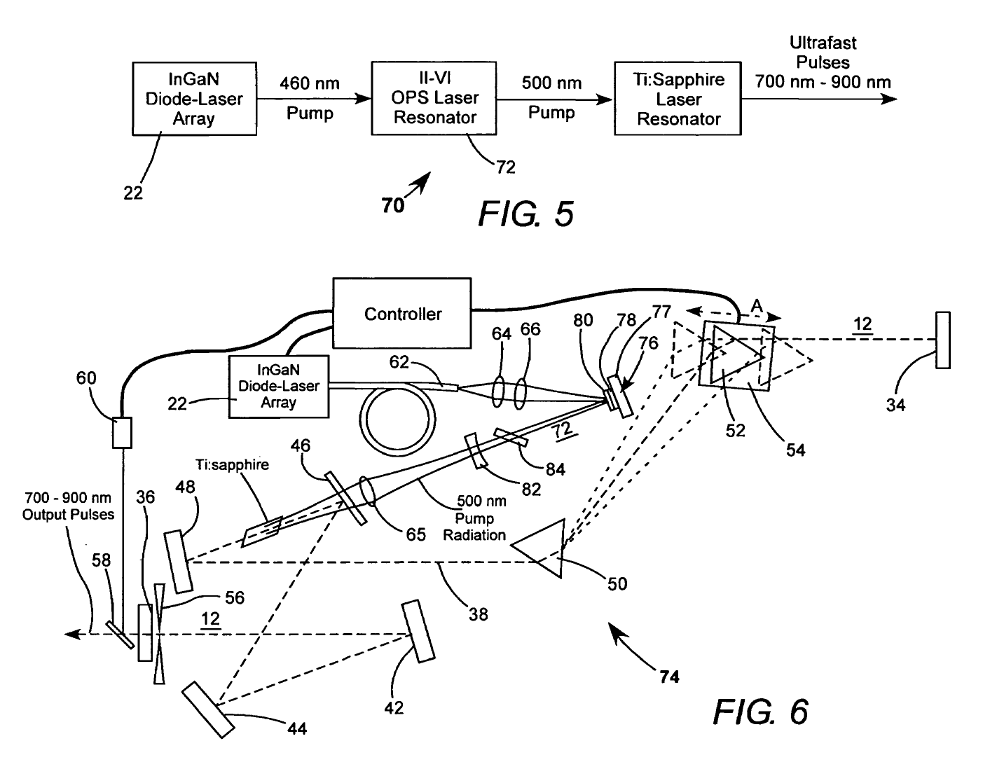

FIG. 5 schematically illustrates, in block diagram form, another preferred embodiment 70 of an ultrafast laser in accordance with the present invention. In laser 70 pump radiation from InGaN diode-laser array 22 is used to optically pump an external cavity II-VI semiconductor laser resonator (OPS-laser resonator) 70, the output of which is used to optically pump Ti:sapphire laser resonator 12. The OPS-laser resonator preferably delivers radiation at the peak-gain wavelength of Ti:sapphire, i.e., at about 500 nm.

FIG. 6 schematically illustrates one example 74 of the laser of FIG. 5, similar to the laser of FIG. 4 but wherein fiber-delivered radiation from the InGaN diode-laser array is focused onto a multilayer gain structure of a II-VI OPS-laser resonator, the output of which used to pump the Ti:sapphire laser resonator. The OPS Laser resonator includes a multilayer OPS structure 76 mounted on a heat sink 77. OPS-structure 76 includes a mirror structure 78 surmounted by a surface-emitting gain-structure 80 including active layers of a II-VI semiconductor material. Preferred such II-VI semiconductor materials include ternary compounds zinc sulfoselenide ZnSₓSe₍₁₋ₓ₎ and ZnₓCd₍₁₋ₓ₎Se (where x is equal to or greater than 0.0 and less than or equal to 1.0). Gain-structures including active layers of these and other II-VI semiconductor materials are capable of providing light at wavelengths in a range from about 460 nm in the blue region of the spectrum to about 530 nm in the green region of the spectrum by selection of an appropriate ternary composition. A detailed description of InGaN-device pumped II-VI semiconductor lasers, both surface-emitting and edge-emitting lasers is provided in U.S. Pat. No. 7,136,408, assigned to the assignee of the present invention, the complete disclosure of which is hereby incorporated by reference.

In system 74, OPS-laser resonator 72 is formed between mirror structure 78 of the OPS-structure and a concave mirror 82. Mirror 82 is partially transmissive at the oscillating wavelength of the OPS-laser resonator and serves as an output coupling mirror. A birefringent filter 84 is located in resonator 72 for selecting the desired output wavelength from the gain-bandwidth of the II-VI gain structure. Pump radiation from the InGaN diode-laser array is delivered by optical fiber 62 and focused by lenses 64 and 66 onto gain-structure 80 for energizing the gain-structure. Output radiation from OPS laser resonator 72 is focused by a lens 65 into the Ti:sapphire gain-element of laser resonator 12.

Apart from an ability to provide pumping of the Ti:sapphire at the peak-gain wavelength, a particular advantage of the Ti:sapphire pumping arrangement exemplified here is that the OPS-laser resonator provides a brighter output than is provided by the InGaN diode-laser array. Further, that output can be provided as a quiet single-mode beam. Disadvantages of the arrangement, compared with direct InGaN pumping, are a less than 100% conversion of the InGaN diode-laser array output to OPS-laser output, and additional space required for the OPS-laser resonator.

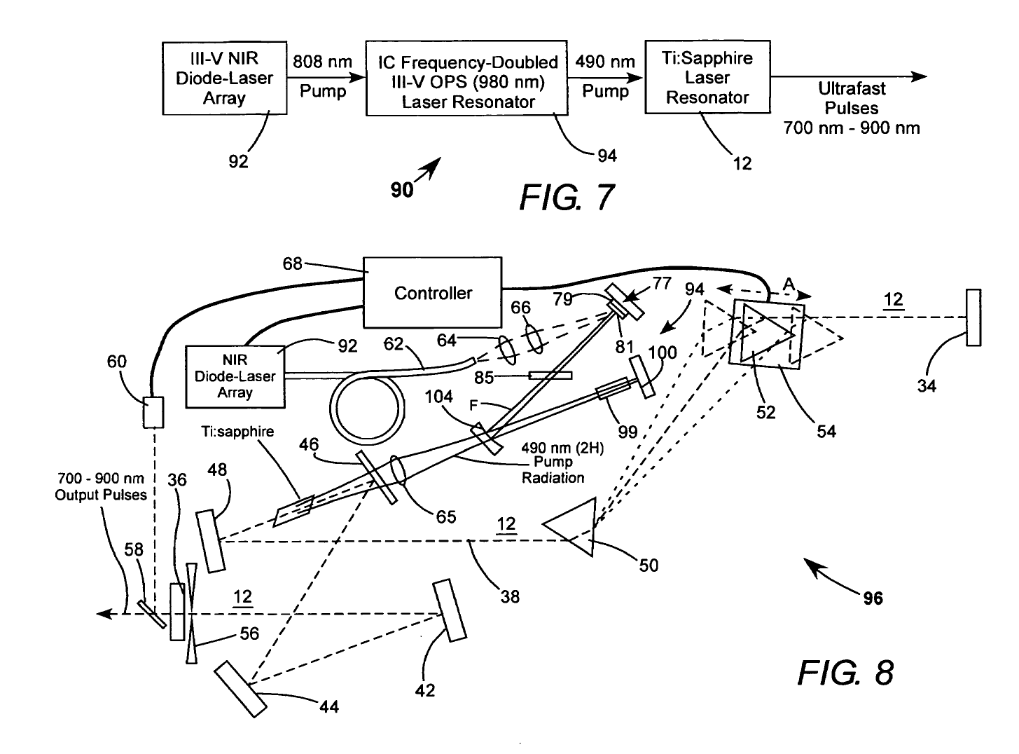

FIG. 7 schematically illustrates, in block diagram form, yet another preferred embodiment 90 of an ultrafast laser in accordance with the present invention. Here radiation from an intracavity, frequency-doubled, III-V NIR OPS-laser, is used to optically pump a Ti:sapphire laser resonator.

FIG. 8 schematically illustrates one example 96 of the laser of FIG. 7, tunable in the gain range of the Ti:sapphire gain medium, similar to the laser of FIG. 6 but wherein the InGaN diode-laser array is replaced by III-V NIR diode-laser array 92, and the II-VI OPS-laser resonator is replaced by intracavity (IC) frequency-doubled OPS-laser resonator 94. Resonator 94 is terminated by mirror structure 79 of an OPS-structure 77 and a mirror 100. Resonator 94 is folded by a concave mirror 104. Pump radiation from the diode-laser array is delivered via fiber 62 and focusing lenses 64 and 66 to a gain-structure 81 of OPS structure 77 for energizing the gain structure and causing fundamental radiation F to circulate in the resonator. An optically nonlinear crystal 99 is located in resonator 94 between mirrors 104 and 100 and is arranged to convert circulating fundamental radiation F to second-harmonic (2H) radiation. Mirror 104 is transparent to the 2H wavelength. A beam of 2H radiation is coupled out of resonator 94 via mirror 104 and is focused by lens 65 into the Ti:sapphire gain-element in Ti:sapphire laser resonator 12.

In this example, fundamental radiation is indicated as having a wavelength of 980 nm, with the 2H radiation, accordingly, having a wavelength of 490 nm, very close to the peak-gain wavelength of Ti:sapphire. This should not be considered as limiting this embodiment of the inventive semiconductor-device-pumped Ti:sapphire lasers. A detailed description of high-power frequency-doubled OPS-lasers is provided in U.S. Pat. No. 6,285,702, assigned to the assignee of the present invention and the complete disclosure of which is hereby incorporated by reference.

It should be noted here that while embodiments the present invention are described above with reference to specific wavelengths and specific examples resonator configurations these wavelengths and resonator configurations should not be construed as limiting the present invention. Other wavelengths and resonator configurations may be selected without departing from the spirit and scope of the present invention. Further while above described examples of present invention include a Ti:sapphire laser resonator, the invention is equally applicable to pumping an optical amplifier including a Ti:sapphire gain-element. Such an amplifier may by a single pass amplifier, a multipass amplifier wherein radiation being amplified makes a predetermined number of passes through a Ti:sapphire gain medium, or a regenerative amplifier, wherein the radiation being amplified circulates through a Ti:sapphire gain medium in a resonant cavity. Pump radiation sources may be operated in either a continuous wave (CW) mode or in a pulsed mode.

In summary, the present invention is described above in terms of a preferred and other embodiments. The invention is not limited, however, to the embodiments described and depicted. Rather, the invention is limited only by the claims appended hereto.

What is claimed is:

1. Laser apparatus, comprising:
one of a master oscillator and an amplifier including a Ti:sapphire gain-medium; and
an optical pumping arrangement including a semiconductor laser device arranged to generate and deliver optical pump radiation to said Ti:sapphire gain medium.

2. The apparatus of claim 1, wherein said semiconductor laser device includes including an indium gallium nitride (InGaN) diode-laser array.

3. The laser of claim 2, wherein said optical pump radiation is radiation emitted by said InGaN diode-laser array.

4. The apparatus of claim 2, wherein said semiconductor laser device is an optically pumped semiconductor laser (OPS-laser) arranged to be optically pumped by radiation emitted by said InGaN diode-laser array, and said optical pump radiation is output radiation of said OPS-laser.

5. The apparatus of claim 1, wherein said semiconductor laser device is an intracavity frequency-doubled OPS-laser and said optical pump radiation is output radiation of said frequency doubled OPS-laser.

6. Laser apparatus, comprising:
one of a master oscillator and an amplifier including a Ti:sapphire gain-medium; and
an optical pumping arrangement arranged to generate and deliver optical pump radiation to said Ti:sapphire gain medium, said optical pumping system including an indium gallium nitride (InGaN) diode-laser array.

7. The apparatus of claim 6, wherein said optical pump radiation is radiation emitted by said InGaN diode-laser array.

8. The apparatus of claim 7, wherein said optical pump radiation is delivered to said Ti:sapphire gain-medium via one or more optical fibers.

9. The apparatus of claim 6, wherein said optical pumping arrangement includes an optically pumped semiconductor (OPS) laser, said OPS laser is optically pumped by radiation emitted by said InGaN diode-laser array, and said optical pump radiation is output radiation of said OPS laser.

10. The apparatus of claim 9, wherein said OPS-laser includes an OPS-structure including a mirror structure surmounted by a multilayer semiconductor gain structure including active layers of a II-VI semiconductor material.

11. The apparatus of claim 10, wherein said II-VI semiconductor material is one of zinc sulfoselenide and zinc cadmium selenide.

12. The apparatus of claim 9, wherein said radiation emitted by said InGaN diode-laser array has a wavelength between about 390 nanometers and 460 nm.

13. The apparatus of claim 12, wherein said output radiation of said OPS laser has a wavelength of about 490 nm.

14. Laser apparatus, comprising:
one of a master oscillator and an amplifier including a Ti:sapphire gain-medium; and
an optical pumping arrangement including intracavity frequency-doubled OPS laser, frequency-doubled output radiation of which is delivered to said Ti:sapphire gain medium for energizing said Ti:sapphire gain-medium.

15. The apparatus of claim 14, wherein said frequency-doubled OPS laser includes an OPS-structure including a mirror structure surmounted by a multilayer semiconductor gain structure including active layers of a III-V semiconductor material.

16. The apparatus of claim 15, wherein said frequency-doubled output radiation has a wavelength of about 490 nm.

17. The apparatus of claim 15, wherein said III-V semiconductor material is indium gallium arsenide.

18. The apparatus of claim 15, wherein said optical pumping arrangement includes an arrangement for focusing said frequency-doubled output radiation into said Ti:sapphire gain medium.
